(19) United States
(12) Patent Application Publication
(10) Pub. No.: US 2001/0051884 A1
(43) Pub. Date: Dec. 13, 2001

(54) Method and system for controlling warranty-related data and services

(76) Inventors: Gidon Wallis, New York, NY (US); Evan Press, Brooklyn, NY (US)

Correspondence Address: CALFEE HALTER & GRISWOLD, LLP, 800 SUPERIOR AVENUE, SUITE 1400, CLEVELAND, OH, 44114, US

(21) Appl. No.: 09/879,767

(22) Filed: Jun. 12, 2001

Related U.S. Application Data
(60) Provisional application No. 60/211,235, filed on Jun. 12, 2000.

(51) Int. Cl. G06F 17/60

(52) U.S. Cl. 705/4

(57) ABSTRACT

A system and method of controlling warranty-related data and services provides centralized management of warranty programs for product vendors and purchasers. Data related to sales of products covered by warranties is compiled and processed and user-specific documents are generated. The documents are stored in the system and can be accessed over a computer network such as the Internet. A system server and control application provide a web site that allows a product purchaser to request a repair of a product under warranty, and then automatically arranges for the repair to be made by contacting a parcel delivery service and a repair center. The system receives period updates regarding the repair of the product, and makes the updates available to the system users in the form of accessible documents. The purchaser is able to quickly and easily obtain a repair for a product and be kept informed as to the status of the repair without expending much effort.

### CROSS-REFERENCE TO RELATED APPLICATIONS

This application claims priority to U.S. Provisional Patent Application No. 60/211,235 filed Jun. 12, 2000, the entire disclosure of which is hereby incorporated by reference herein.

### FIELD OF THE INVENTION

The present invention relates to computer-based commerce. It finds particular application to a warranty administration method and system which provides warranty-related services, including the sale of warranties, the initiation of repairs made pursuant to a warranty, and the creation, maintenance and display of records reflecting various aspects of warranty commerce, all over the Internet.

### BACKGROUND OF THE INVENTION

Billions of dollars are spent each year on products which are covered by warranties. Over and above the purchase price paid for the product, consumers frequently pay a premium for extended or enhanced warranty coverage for the products they purchase. Like other forms of insurance, warranties are typically not at the forefront of a consumer's mind until the coverage they provide is needed. That is, a warranty becomes important when a product fails to perform its intended function. Unfortunately, in addition to the aggravation inherent in buying a defective product, traditional warranty programs make obtaining a repair for the product extremely inconvenient for the aggrieved purchaser. For instance, obtaining a repair frequently requires the consumer to personally transport the product to the product's retailer or authorized repair center. Or if the product is too large to be transported by the consumer, the consumer has to arrange for an on-site repair service to come to his home or office to make the repair. As for the product that the consumer transported to the repair center, chances are that the consumer will have to pick up the repaired product himself. Therefore, in spite of the fact that the product is defective through no fault of the consumer, management of the repair process, and all of the inconvenience inherent therein, is the consumer's burden to bear.

Recently, electronic or “e-commerce” has emerged as a convenient method for consumers to purchase a variety of goods. In fact, e-commerce has become so prevalent that it is a normative way of conducting sales transactions. Consumers are now spending billions of dollars annually simply by “clicking” on products that appear on their computer screens. Shopping via global computer networks such as the Internet has proven to be both convenient and efficient, and it appears as though sales made over the Internet will only increase in the future. Despite this increased ease and convenience in purchasing products, the management of repairs to these goods is no more convenient than it was prior to the advent of e-commerce—the burden is still on the consumer, and the burden is no different than it is in the brick-and-mortar retailing model. The simplicity and convenience of e-commerce shopping has yet to be extended to the warranty and repair management industry.

A few prior art warranty management systems include web sites offering extended warranties to consumers. These sites require consumers to provide the site hosts with all of the information necessary for the issuance of a warranty. Therefore, even though these warranty programs owe their existence to the consumers who purchase their warranties, they inconvenience the consumers from the very start. And in return, the consumers are merely provided with a telephone number or an Internet address of a local repair center to contact in the event that a repair to a product is required. The consumer may additionally or alternatively be provided with a phone number to reach a technical support provider or an on-site service provider for larger products. But no matter what these systems provide to a consumer, they require the consumer to manage the repair of the product himself. The consumer is still responsible for either arranging for the product to get to and from the repair center—including the possibility that the consumer may have to transport the product himself—or making the arrangements necessary to have an on-site service provider come into his home. In essence, these web sites provide nothing more than another variation of the traditional brick-and-mortar repair reference service.

Three such prior art systems are embodied at rebox.com, servicenetdirect.com, and warrantysuperstore.com. These systems enable consumers to manage the repair of products, regardless of the vendor of the products, from a single website. However, all of these systems require that the consumer personally enter all of the product data required for the warranties on these products. Moreover, none of these systems save the consumer from having to make all of the repair arrangements himself. Two other systems, embodied at warrantynow.com and repair.com, require the consumer to make his own arrangements for the transport of the product to a service center as well.

The present invention provides a new and unique warranty administration system and method that cures the above problems and others.

### SUMMARY OF THE INVENTION

The present invention simplifies the warranty administration process and makes the purchase of extended warranty protection more attractive to consumers. The inventive system and method described herein are designed to manage a warranty program in such a way that the burden placed on product purchasers and vendors is minimized. The process starts as digital records of a product sale are transmitted by the vendor to the system. Because maintaining computer records of sales is a common business practice for many vendors, the simple act of transmitting the records is hardly a burden to the vendors. More importantly, the purchaser personally does not have to do anything to start the warranty process. The act of making a purchase essentially generates all of the information necessary to administer the warranty process.

Once the record of the product sale is transmitted to the system of the present invention, the system generates and sends an electronic message to the purchaser of the product. The message introduces the purchaser to the system and its services. The message also instructs the purchaser as to the simplicity of the system in the event that a repair to the product becomes necessary. Through the system, the purchaser is able view an on-line account of all of his purchases and the warranty plans covering each product. If one of the products requires servicing, the purchaser simply electronically selects an option which requests the initiation of the repair process.

Upon receipt of a request for repair, the system notifies a parcel delivery service to pick up the product and deliver it to a repair center. The system also notifies the repair center that the product will be delivered for service. Therefore, after merely requesting a repair for his product, the purchaser's responsibility in managing the repair process is complete. The process is then controlled by the system of the present invention until the repaired product is returned to the purchaser.

The vendor, parcel delivery service, and the repair center are all able to access their own accounts within the system as well. The system generates the accounts automatically. The vendor can view a list of all of the products it has sold, and the warranty plan covering each product. The system also performs data analysis functions for the benefit of the vendor. For example, the vendor can view a report which analyzes the percentage of extended warranties sold for a certain type of product, or for all products in a particular price range. This information is valuable for future business decisions to be made by the vendor.

The parcel delivery service and the repair center access the system so that users of the system, including the parcel delivery service and the repair center themselves, can track the progress or status of product repairs. The parcel delivery service and the repair center transmit status updates to the system, and the updates can then be viewed by the system's users. This allows for efficient coordination between the parcel delivery service and the repair center, and it keeps the purchaser informed of the status of the repair to his product. This is comforting for the purchaser, and it is convenient for the vendor, the parcel delivery service, and the repair center because they will not need to field telephone calls from the purchaser (or each other) inquiring as to the status of the repair.

By controlling the warranty administration process over a computer network, the system of the present invention makes the process more convenient and efficient for all interested parties. For the invention to operate effectively, it is not necessary that all of the system's users utilize the same computer network, such as the Internet. For instance, the parcel deliver service's system could be partially or totally integrated into the inventive system. The crux of the invention is that having the user systems networked in some way to the system of the present invention allows for the central control of the warranty administration process and minimizes the burden on all parties involved in the process.

Therefore, in accordance with the present invention, a process for controlling the repair of a product under warranty is provided. Information regarding a sale of a product under a warranty plan is compiled in a host system. A data transmission is sent to the purchaser of the product over a computer network, and the data transmission contains an instruction for initiating a repair to the product. The purchaser is provided with access to the host system via a computer network. A request for a repair to the product is received in the host system. A parcel delivery service is notified to pick up the product and deliver it to a repair center, and the repair center is notified that the product will be delivered for repair. A report regarding the repair of the product is generated and stored as a document maintained in the host system. One or more status updates regarding the repair of the product are received. The report is amended to reflect the status updates. The purchaser is provided with access to the report over a computer network.

In accordance with a more limited aspect of the present invention, a vendor of the product is provided with access to the host system and the host system receives the information regarding the sale of the product from a data transmission from the vendor over a computer network.

In accordance with a more limited aspect of the present invention, the parcel delivery service and the repair center are provided with access to the host system and the report over a computer network.

In accordance with a more limited aspect of the present invention, the repair request and the one or more status updates are received via transmission over a computer network.

In accordance with yet a more limited aspect of the invention, a purchaser-specific account is generated and maintained within the host system. The purchaser-specific account includes a plurality of selectable options that allow the purchaser to select and view a list of the one or more products purchased by the purchaser, to cancel or amend a warranty plan for one or more of each of the products on the list, initiate a repair of one or more of each of the products on the list, and to view a report corresponding to the repair of each product for which a repair was initiated.

In accordance with another embodiment of the present invention, a process for administering a warranty program for a plurality of products is provided. One or more data transmissions are received into a host system over a computer network. Each of the data transmissions contains an assemblage of information corresponding to at least one sale of at least one product. Every product sold is identified in the information, and for every product identified, a vendor, a purchaser, and a warranty plan corresponding to each product is also identified. A vendor account is generated for each vendor ultimately identified in the one or more data transmissions. Each vendor account displays a list of each product sold by the particular vendor for whom a vendor account was generated. The vendor account also displays the purchaser and the warranty plan of each product identified as being sold by the vendor. The vendor account is stored as a document in the host system, and the vendor is provided with access to the vendor account over a computer network. A purchaser account is also generated for each purchaser ultimately identified in the one or more data transmissions. Each purchaser account displays a list of each product bought by the particular purchaser for whom a purchaser account was generated. The purchaser account also displays the vendor of each of the products listed in the purchaser account as well as the warranty plan covering each product listed in the purchaser account. The purchaser account is stored as a document in the host system, and the purchaser is provided with access to the purchaser account over a computer network. A set of instructions for for accessing the host system is transmitted to the purchaser over a computer network.

### BRIEF DESCRIPTION OF THE DRAWINGS

The following is a brief description of each drawing used to describe the present invention, and thus, is being presented for illustrative purposes only and should not be limitative of the scope of the invention, wherein:

FIG. 1 is an overall diagram of the present invention;

FIG. 2 is a block diagram of the control application in accordance with the present invention;

FIG. 3 is a process diagram for administering a warranty program and the repair of a product under a warranty;

FIG. 4 is a block diagram of a vendor account document in accordance with the present invention;

FIG. 5 is a block diagram of a purchaser account document in accordance with the present invention;

FIG. 6 is a block diagram of a repair center account document in accordance with the present invention;

FIG. 7 is a block diagram of a parcel delivery service account document in accordance with the present invention.

### DETAILED DESCRIPTION OF THE INVENTION

The following includes definitions of exemplary terms used throughout the disclosure. Both singular and plural forms of all terms fall within each meaning:

“Document”, as used herein, includes but is not limited to an electronic document, a web page or any object having text.

“Software”, as used herein, includes but is not limited to one or more computer executable instructions, routines, algorithms, modules or programs including separate applications or ones from dynamically linked libraries for performing functions as described herein. Software may also be implemented in various forms such as a servlet, an applet, a standalone program including a server based application and a user based application, a plug-in or other type of application. Software may also be stored on various computer readable mediums such as disk, CD, tape, memory and can be downloadable.

“Logic”, as used herein, includes but is not limited to hardware, software and/or combinations of both to perform one or more functions.

“Network”, as used herein, includes but is not limited to the Internet, intranets, Wide Area Networks (WANs), Local Area Networks (LANs), and transducer links such as those using Modulator-Demodulators (modems).

“Internet”, as used herein, includes a wide area data communications network, typically accessible by any user having appropriate software.

“Intranet”, as used herein, includes a data communications network similar to an internet but typically having access restricted to a specific group of individuals, organizations, or computers.

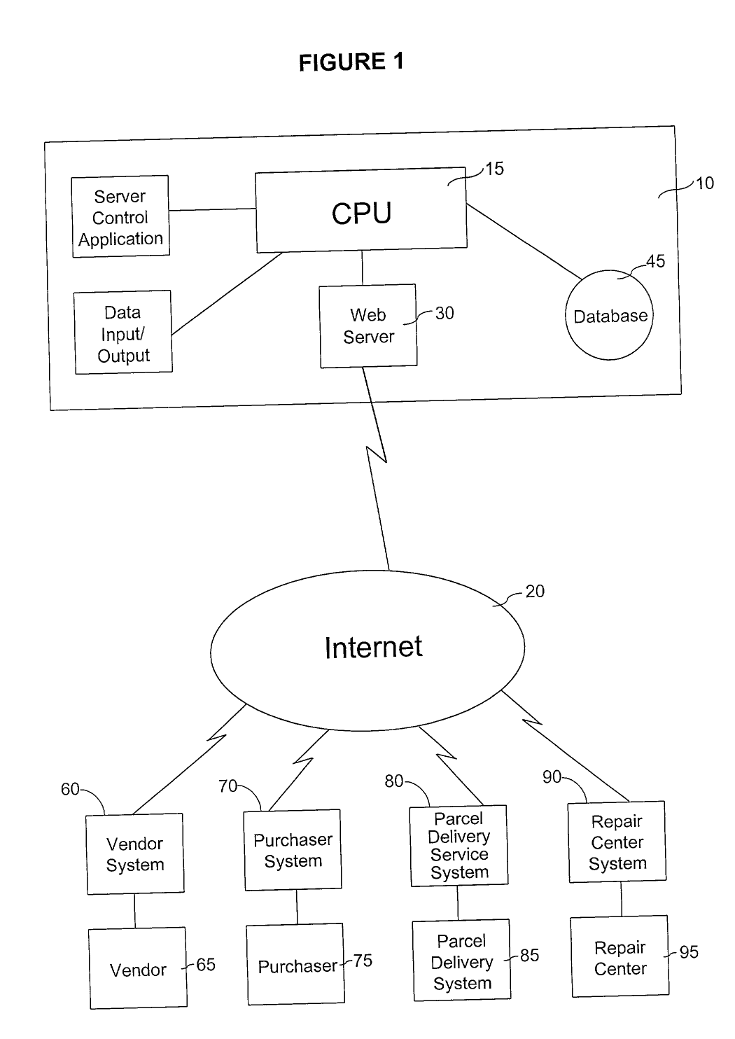

With reference to FIG. 1, a system for controlling a warranty program and controlling the repair of a product under warranty in accordance with the present invention is shown. The system includes a host system 10 of one or more computers which includes a central processing unit 15 that controls the overall functionality of the system. The host system 10 communicates to the Internet 20 via a web server 30 or other network connectivity devices as are known in the art. Of course, it will be appreciated that the present invention may be configured with other types of computer networks as are known to those of ordinary skill in the art. A series of user systems, including one or more vendor systems 60, one or more purchaser systems 70, one or more parcel delivery systems 80, and one or more repair center systems 90, are provided with access the host system 10 over the Internet 20 or other network. The present invention may also be configured so that access to the host system 10 is limited to any combination of one or more of the user systems 60, 70, 80, 90 depicted in FIG. 1. Through their respective user systems 60, 70, 80, 90, one or more vendors 65, one or more purchasers 75, one or more parcel delivery services 85, and one or more repair centers 95 are able to access the Internet 20 via any appropriate mechanism of Internet connectivity, such as a personal computer including a modem to dial-up an Internet Service Provider.

With further reference to FIG. 1, the server system 10 includes a database 45 that maintains data relating to the sale of a product, a warranty plan covering the product, and any repairs requested or performed on the product. The data is processed and one or more documents related to the data are generated by the host system 10. These documents will be described in greater detail below. It will be appreciated that the database 45 may include one or more databases based on desired data orientation. A server control application 50 is software executed by the server system 10 that controls the functionality of the server system 10. For example, the control application 50 maintains and provides access to the database 45, controls data communication to the web server 30, defines all web pages accessible by a user 65, 75, 85, 95 at a web site, and defines navigational and page link control. A data input/output component 55 provides for the transfer of data to and from the central processing unit 15, including the documents generated and maintained within the host system 10. The data input/output component 55 includes a magnetic/digital disc device, serial/parallel communication lines, or other data transfer devices as are known in the art.

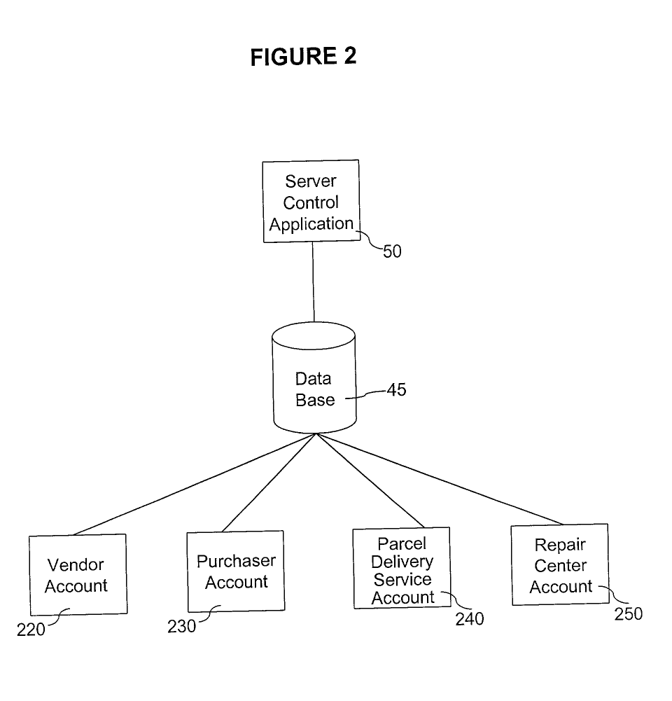

With reference to FIG. 2, functions of the overall system and server control application 50 are shown. In particular, server control application 50 includes logic for controlling the generation and amendment of documents stored in the host system 10, as well as generating and transmitting electronic messages to vendors, purchasers, parcel delivery services, and repair centers. This includes processing and storing new data in appropriate records corresponding to a sale of one or more products under warranty, modifying existing data in the database, and retrieving data from the database 45 to be presented to the user 65, 75, 85, 95 at the user system 60, 70, 80, 90. Among the documents stored in the host system 10 are one or more vendor accounts 220. A vendor account is a document through which a vendor 65 is provided with access to a series of additional documents containing information relevant to one or more products sold by the vendor 65. The documents contained in the vendor account 220 also provide the vendor 65 with one or more selectable options for initiating actions to be executed by the host system 10. The documents provided to the vendor 65 will be described in greater detail below. Also included in the host system 10 is one or more purchaser accounts 230. The purchaser account 230 is a document through which a purchaser 75 is provided with access to a series of additional documents containing information relevant to products purchased by the purchaser 75 which are covered by a warranty. These documents also provide the purchaser 75 with one or more selectable options for initiating actions to be executed by the host system 10. The documents provided to purchaser 75 will be described in greater detail below. The host system 10 also includes one or more Parcel Delivery Service Accounts 240. Through the Parcel Delivery Service Account 240, the server control application 50 receives and stores status updates from the parcel delivery service 85 regarding the status of a delivery of a product for which a request for repair has been made. The parcel delivery service account 240 includes logic for tracking the repair of a product and makes this data accessible to the parcel delivery service 85. And a Repair Center Account 250 allows a repair center 95 to view a list of all of its presently pending repairs, report a delayed repair, and/or report the completion of a repair. The documents contained in the parcel delivery service account 240 and the repair center account 250 will be described in greater detail below.

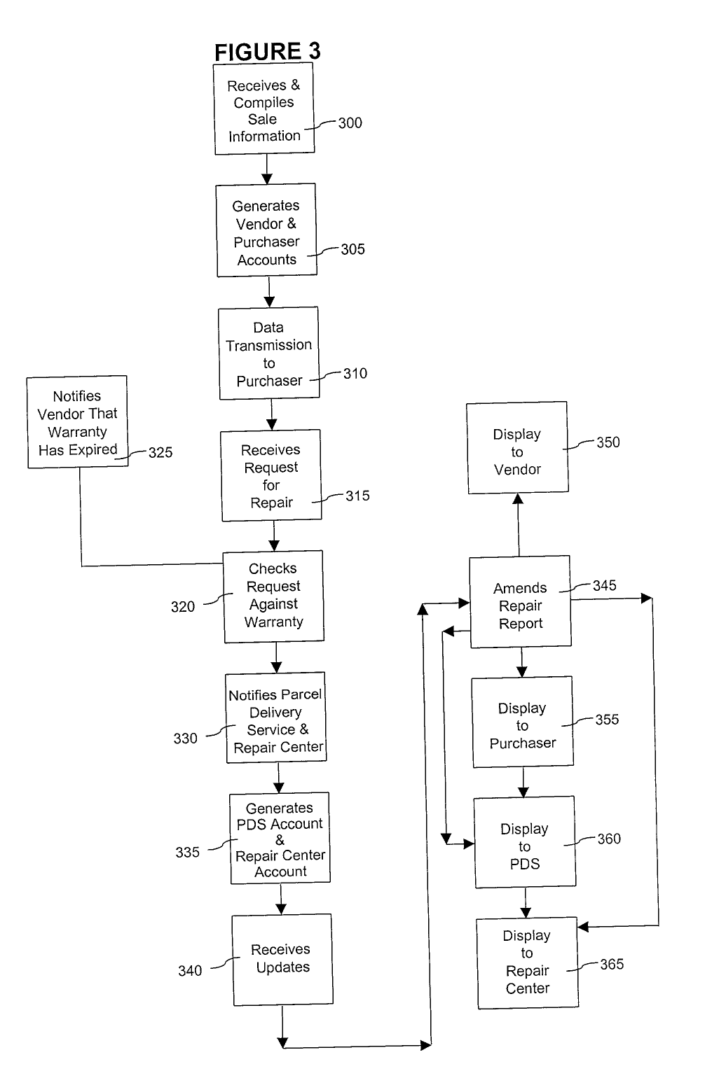

Referring to FIG. 3, a process for controlling warranty related data and controlling a repair to a product under a warranty is shown. It will be appreciated that the logic of the host system 10 can be employed to perform the invention for a plurality of products, but, for exemplary purposes, the following description refers to only the process as it occurs for one product at a time. At block 300, the host system 10 receives and compiles information related to the sale of a product. In one embodiment, the information is transmitted by the vendor 65. In one embodiment of the invention, sale of the product occurs as the purchaser 75 buys the product from the vendor over a computer network, where multiple data transmissions may be exchanged between the vendor and the purchaser in the selection of the product and the confirmation of the sale. The information is transmitted to the host system via any known method of communication for example, a computer network. The information contains at least the identity of the product sold, the details of the warranty plan covering the product sold, and the identity and contact information of the purchaser 75 of the product sold. Regarding the identity of the product, the information includes, for example, a make and model number of the product, as well as a purchase price of the product. Regarding the details of the warranty plan, the information includes for example, the duration of the warranty and applicable terms and conditions. The contact information includes, for example, an e-mail address, home address, and telephone number of each purchaser 75 identified in the data transmission.

At block 305, the host system 10, generates a vendor account 220 and a purchaser account 230 and stores each account in the database 45. This occurs as the logic of the server control application 50 causes the information transmitted into the host system 10 to be processed, thereby establishing the identities the vendor 65 and the purchaser 75 of the product. Once the vendor 65 and the purchaser 75 are identified, a vendor account 220 specific to the vendor 65 identified in the information is established. The server control application 50 processes the remainder of the information and establishes an association between the vendor 65, the purchaser 75, and the product identified in the information received by the host system. This association allows the information to be presented and maintained in the appropriate document or documents within the vendor account 220. A purchaser account 230 specific to the purchaser 75 identified in the information is also established after the purchaser 75 is identified. As it did with the vendor account 220, the server control application 50 processes the remainder of the information so that it may be presented in the appropriate document or documents within the purchaser account 230.

In the event that the vendor account 220 and/or a purchaser account 230 already exist for the particular vendor 65 or purchaser 75 identified in the information transmitted into the host system 10, no new accounts will be generated. The information will be processed as above, and after the logic of the control application 50 establishes the appropriate association between the vendor 65, the purchaser 75, and the product, the existing vendor account 220 and/or purchaser account 230 will be amended to reflect the new product and warranty information received by the host system 10.

At block 310, data is transmitted over a computer network to the purchaser 75. For example, this data transmission is in the form of an e-mail message. The data includes instructions for the purchaser 75 to access the host system 10. The instructions explain, for example, how the purchaser 75 can employ the host system 10 for administering the warranty covering the product. This includes an explanation of the repair initiation and tracking services provided by the host system 10, and an explanation of how the purchaser can buy extended warranty coverage or cancel existing warranty coverage for the product. The instructions may also include a purchaser-specific password required for the purchaser 75 to access the Purchaser Account 230.

At block 315, a request for a repair to the product is received into the host system 10. In one embodiment of the invention, the request is received as the result of the purchaser 75 selecting an option for repair that is provided to the purchaser 75 in the purchaser account 230. This selection could occur, for example, by the purchaser locating the option for repairing a product displayed on his computer monitor and clicking it. The server control application 50 checks the request against the terms of warranty plan for the product at block 320. If the warranty covering the product expired prior to the request being made, notification to that effect is transmitted to the purchaser 75 at block 325. If the product is under its warranty at the time of the request, then a repair request is generated and transmitted to the parcel delivery service 85 and the repair center 95 as notification, and a repair report for the product is generated in the host system 10 at block 330. In another embodiment of the invention, the system will not allow the purchaser 75 to request a repair of a product whose warranty has expired. The logic of the server control application 50 determines the appropriate parcel delivery service 85 and repair center 95 to notify based upon factors including the nature of the product needing repair and the address of the purchaser 75. In one embodiment of the present invention, the notice is sent to the parcel delivery service 85 and the repair center 95 over a computer network. The repair report, for example, identifies the product to be repaired, the purchaser 75 of the product, the parcel delivery service notified, the repair center notified, and the date that the request was made.

At block 335, a parcel delivery service account 240 and a repair service account 250 are generated by the host system 10 and stored in the database 45. The parcel delivery service account 240 and the repair service account 250 are generated in much the same way as are the vendor account 220 and the purchaser account 230.

At block 340 one or more updates regarding the status of the repair are received by host system 10 from the parcel delivery service 85 and/or the repair center 95. The updates include, for example, reports such as the location of the product as it is in transit to or from the purchaser 75 or the repair center 95. The updates can also include the time and date that the product is delivered to or picked up from the repair center 95. Moreover, the updates can also include reports regarding the progress or completion of the repair, or the estimated time of completion. In one embodiment of the present invention, the one or more updates are transmitted into the host system 10 over a computer network. In one embodiment, the host system 10 provides selectable options provided in the parcel delivery service account 240 and/or the repair center account 250 for the parcel delivery service 85 and/or the repair center 95 to transmit the updates to the host system 10. At block 345, server control application 50 provides for the repair report to be amended to reflect the one or more status updates received by the host system 10.

At block 350, the host system 10 provides the vendor 65 with an option to view a display of the repair report. The repair report is displayed to the purchaser 75 at block 355 if a request for the display of the repair report is received into the host system 10 from the purchaser 75. At block 360, the repair report is displayed to the parcel delivery service 85 if a request for the display of the repair report is received into the host system 10 from the parcel delivery service 85. At block 365, the repair report is displayed to the repair center 95 if a request for the display of the repair report is received into the host system 10 from the repair center 95. It is preferred that any request for viewing the repair report be received as the result of the vendor 65, purchaser 75, parcel delivery service 85 and/or the repair center 95 selecting an option for viewing the report that is presented in the vendor account 220, the purchaser account 230, the parcel delivery service account 240 and/or the repair center account 250, respectively. At the completion of the repair, the product will be returned to the purchaser 75 from the parcel delivery service 85.

As alluded to above, the process outlined in FIG. 3 can also be employed to administer a warranty program for a plurality of products, or to administer the repair of a plurality of products. The host system 10 is capable of receiving multiple data transmissions, each data transmission containing an assemblage of information. An assemblage of information includes, for example, the sale of multiple products made by one vendor to multiple purchasers. In such a case, the logic of the server control application 50 generates a vendor account 220 for the one vendor 65, wherein the vendor account 220 contains, for example, information regarding the sale of every product identified within the assemblage of information. In the event that the control application 50 determines that a vendor account 220 is already in existence for the vendor 65 identified in the assemblage of information, the existing vendor account is updated with the new sales information contained in the assemblage of information. A purchaser account 230 is also generated for each purchaser 75 identified in the assemblage of information. Each purchaser account 230 contains, for example, sales information pertaining only to the products bought by the purchaser 75 for whom the purchaser account 230 was established. As with the vendor accounts 220, if a purchaser account 230 is already maintained within the database 45 for one or more of the purchasers 75 identified in the assemblage of information, then the existing purchaser account 230 or accounts are amended accordingly. The host system 10 is also able to receive data transmissions from multiple vendors. The assemblage of information contained in each data transmission will be processed in the same manner as described above.

The host system 10 is also able to process multiple requests for repair from multiple purchasers, with the process outlined in FIG. 3 beginning at block 315 then occurring for each request made.

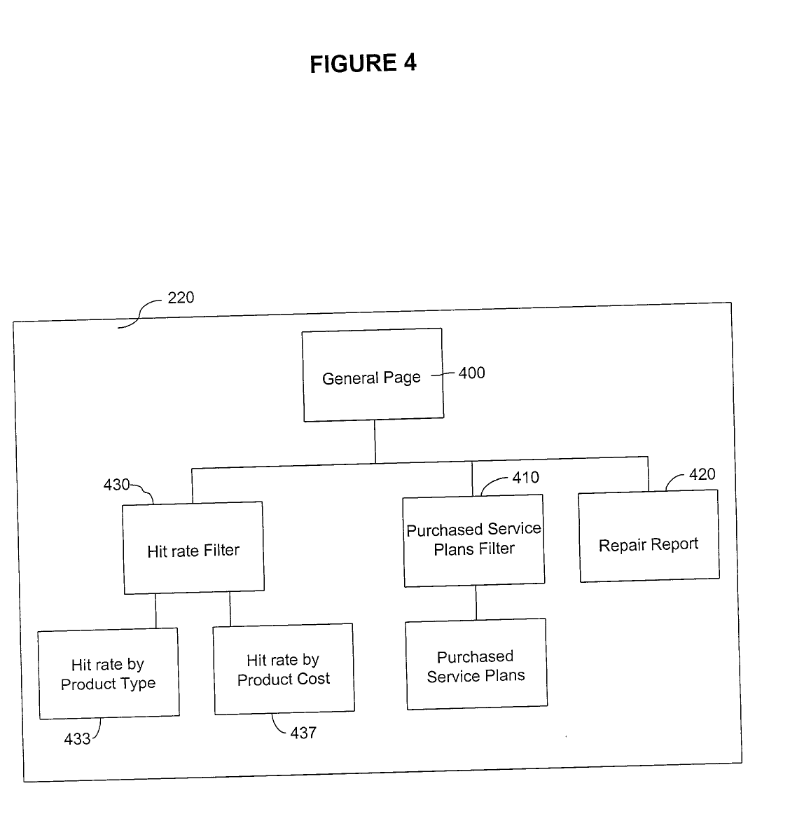

Regarding FIG. 4, an embodiment of a vendor account 220 is shown. A general page 400 allows the vendor 65 to access and view other documents contained within the vendor account 220. For instance, the vendor 65 is provided access a Service Plans Report document 410 that provides a list of all products sold by the vendor 65 that are covered by a warranty. The vendor is also provided with the option of viewing the details of the warranty plan covering any of the products listed through access to the Service Plans Report document 410. In addition, a Repair Report document 420 is also provided in the vendor account 220, allowing the vendor to view a list of products sold by the vendor for which a repair has been requested, is pending, or has been completed. Through the Repair Report document 420 the vendor 65 is also provided with the option of viewing the detailed status of any requested or pending repairs. The vendor account 220 may additionally include a Hit Rate Report 430, which provides the vendor 65 with an analysis of the percentage of products sold for which an extended warranty plan was purchased (the “hit rate”). The vendor 65 is also provided with the option of viewing the hit rate computed by product type 433, e.g. televisions, or the hit rate by product cost 437, which for example, would provide the percentage of extended warranty plans purchased for products costing over $2000.00, or between $250.00 and $500.00, or by any cost parameter selected by the vendor 65.

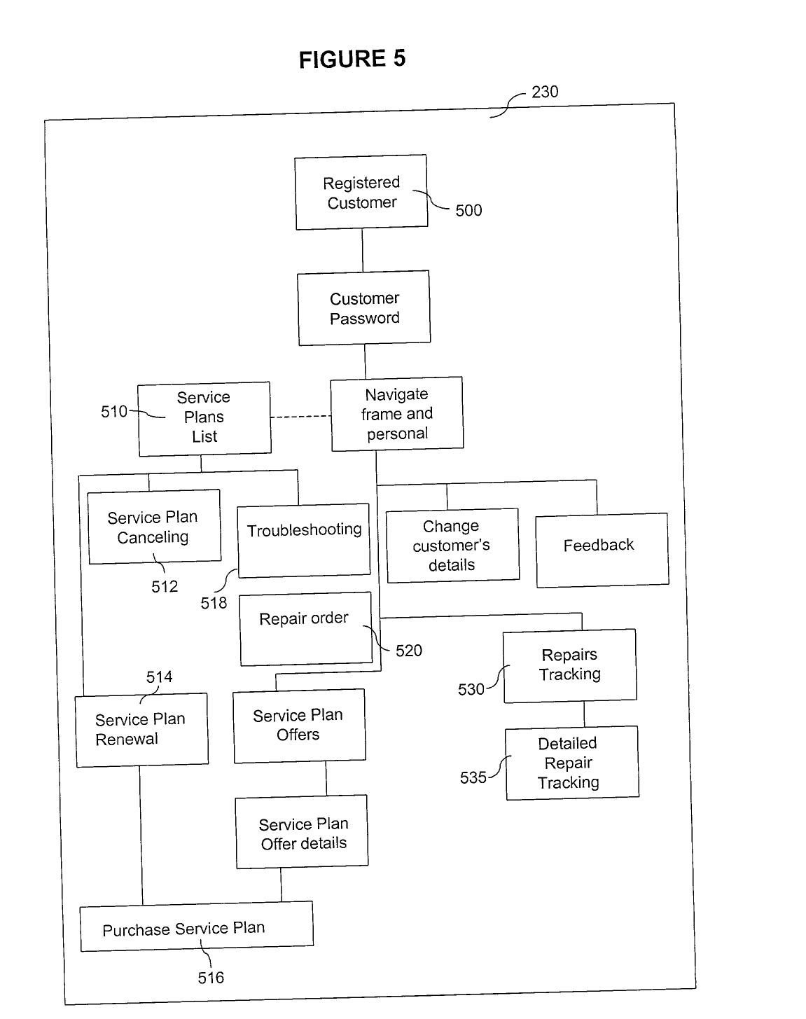

With reference with FIG. 5, an embodiment of a purchaser account 230 is shown. A general page 500 allows the purchaser 75 to access and view other documents contained within the purchaser account 230. The purchaser is provided with access to a Service Plans List document 510 which identifies the warranty plan covering each product purchased by the purchaser 75. From the Service Plans List document 510, the host system 10 allows the purchaser 75 to access a Service Plan Canceling document 512, a Service Plan Renewal document 514, a Purchase Service Plan document 516, a Troubleshooting document 518, and a Repair Order document 520.

Consistent with its name, the Service Plan Canceling document 512 provides the purchaser 75 with the option of canceling warranty protection for any of the products listed in the Service Plans List 510. In one embodiment of the invention, the control application 50 determines the amount of the warranty purchase price to be refunded to the purchaser 75 upon cancellation. The refund is calculated by determining the purchaser's 75 state of residence, and then utilizing a formula consistent and in compliance with the laws of that state for issuing refunds. In addition to canceling warranty protection, the purchaser 75 is provided with the option of renewing the terms of any of his warranties through the Service Plan Renewal document 514, and buying an extended warranty plan at the Purchase Service Plan document 516. If one of the purchaser's products is not operating properly, the host system allows the purchaser 75 to attempt to diagnose the product's defect by accessing the Troubleshooting document 518. The troubleshooting document 518 provides a list of various malfunctions particular to the product identified by the purchaser 75. The troubleshooting document 518 then attributes a possible cause for each malfunction, and if applicable, instructs the purchaser 75 how to remedy the malfunction himself. In the event that a product needs repair, the host system 10 provides the purchaser 75 with an option to request the repair through the Repair Order document 520. In one embodiment of the invention, a list of all of the products bought by the purchaser for which warranty protection is available is displayed in the Repair Order document 520, and the purchaser 75 is provided with the option of initiating the repair process by simply highlighting and selecting the product requiring repair. A Repairs Tracking document 530 is also provided for access in the Purchaser Account 230. From the Repairs Tracking document 530, a Detailed Repair Tracking Document 535 is also provided. The Repairs Tracking document 530 and the Detailed Repair Tracking Document 535 are provided to allow the purchaser 75 to view a list of all the products for which a repair is in process, or to allow the purchaser to view the status of each repair or to track the repair of a specific product through accessing the Repair Tracking document 530.

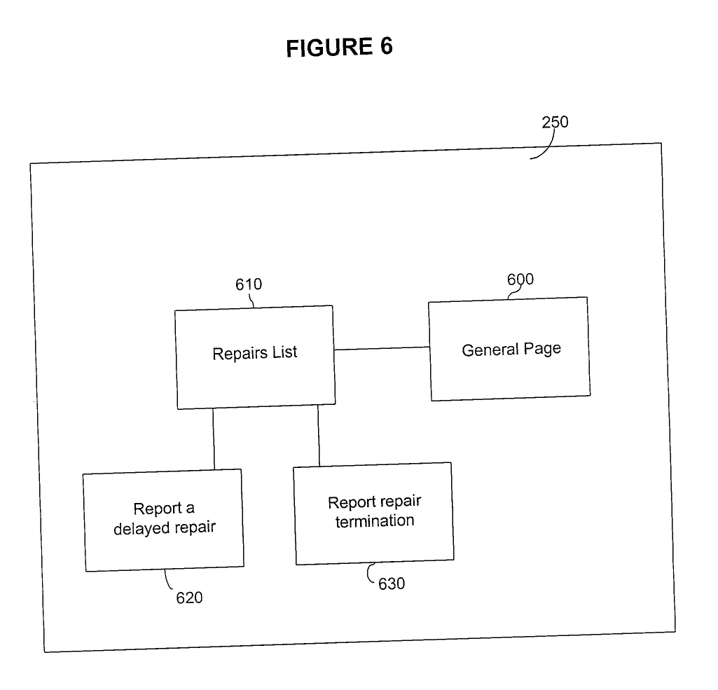

Referring to FIG. 6, an embodiment of a repair center account 250 is shown. The repair center account 250 provides a General Page document 600 which allows the repair center 95 to access and view other documents contained within the repair center account 250. A Repairs List document 610 provides with a display of all of the repairs pending at the repair center 95. From the Repairs List document 610, the host system 10 provides the repair center with the option of electronically transmitting a report of a delayed repair at Delayed Repair document 620 or a terminated repair at Terminated Repair document 630. The information in the reports received by the host system 10 through the Repairs List document 610 are appended into the Repairs Tracking document 530 in the Purchaser Account 230.

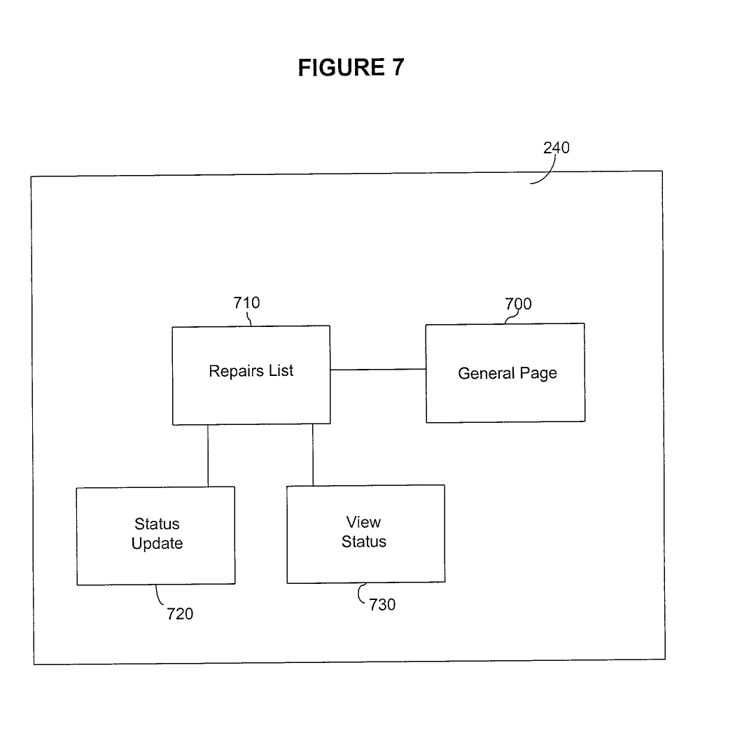

Referring to FIG. 7, the embodiment of the parcel delivery service account 240 is shown. A general page document 700 is provided, and allows a parcel delivery service 85 to access and view other documents contained within the parcel delivery service account 240. A Repairs List document 710 allows the parcel delivery service 85 to view a list of all the products for which delivery has been requested or is pending. The Repairs List document 710 provides the parcel delivery service with the option of updating the status of a delivery at a Status Update document 720 or viewing the status of a repair at a View Status document 730. In another embodiment of the invention, the parcel delivery service system 80 is partially or fully integrated with the host system 10, and the tracking software employed by the parcel delivery system to track its own deliveries automatically transmits status updates to the host system 10. Any status updates received from the parcel delivery service 85 are appended into the Repairs Tracking document 530.

The invention has been described with reference to the preferred embodiment. Obviously, modifications and alterations will occur to others upon a reading and understanding of this specification. It is intended to include all such modifications and alterations as they come within the scope of the appended claims or the equivalence thereof.

What is claimed is:

1. A process for controlling a repair of a product under warranty, the process comprising the steps of:
compiling information in a host system regarding a sale of the product under warranty, the information identifying the product, a vendor of the product, a purchaser of the product, and a warranty plan for the product;
providing the purchaser with a set of instructions for initiating a repair of the product via a transmission of data over a computer network;
providing the purchaser with access to the host system via a computer network;
receiving a request for a repair to be made to the product in the host system;
notifying a parcel delivery service to pick up the product from the customer and deliver the product to a repair center;
notifying the repair center that the product will be delivered for repair;
generating a report regarding the repair of the product;
storing the report in a document maintained within the host system;
receiving one or more status updates from the parcel delivery service or the repair center containing information regarding the repair of the product;
amending the report to reflect the information contained in the one or more status updates;
providing the purchaser with access to the report over a computer network.

2. The process as set forth in claim 1 wherein the controlling of the repair of a product under warrant further includes:
providing the vendor with access to the host system via a computer network; and
the compiling information regarding the sale of the product under warranty further includes receiving the information via a transmission from the vendor over a computer network.

3. The process as set forth in claim 2 wherein the controlling of the repair of a product under warranty further includes:
providing the parcel delivery service and the repair center with access to the host system via a computer network; and
receiving the request for a repair and the one or more status updates in the host system via transmission over a computer network.

4. The process as set forth in claim 3 wherein the controlling the repair of a product under warranty further includes:
maintaining a purchaser-specific account within the host system; and
providing the purchaser with access to the purchaser-specific account via a computer network.

5. The process as set forth in claim 4 wherein the maintaining customer-specific account further includes:
displaying a plurality of selectable options;
allowing the selection of one of the selectable options;
receiving a selection; and
displaying a document corresponding to the selection.

6. The process as set forth in claim 5 wherein the selectable options include:
viewing a display of a list of one or more products purchased by the purchaser;
canceling or purchasing a warranty plan for each one of the one or more products displayed on the list;
initiating a repair for one or more of each of the one or more products displayed on the list; and
viewing a report corresponding to each of the one or more products for which a repair was a initiated.

7. The process set forth in claim 6 wherein the sale of the product under warranty is made via one or more transmissions between the purchaser and the vendor over a computer network.

8. The process as set forth in claim 7 wherein providing the purchaser, the vendor, the parcel delivery service, and the repair center with access to the host system includes providing a website including a user interface accessible over the Internet, the user interface providing one or more selectable options.

9. A process for controlling warranty-related data and services for a plurality of products, the process comprising the steps of:
receiving one or more data transmissions into a host system over a computer network, each one of the one or more data transmissions containing an assemblage of information corresponding to at least one sale of at least one of the plurality of products;
identifying within each assemblage of information each one of the at least one of the plurality of products sold;
identifying within each assemblage of information a vendor, a purchaser, and a warranty plan corresponding to each one of the at least one of the plurality of products sold;
establishing an association between each one of the at least one of the plurality of products and the vendor, the purchaser, and the warranty plan corresponding thereto;
generating a vendor account for each vendor identified in the one or more assemblages of information, the vendor account comprising a display of each one of the at least one product sold by the vendor, where the display includes the purchaser of each one of the at least one product sold by the vendor and the warranty plan for each one of the at least one product sold by the vendor;
storing the vendor account as a document in the host system;
providing the vendor with access to the vendor account via a computer network;
generating a purchaser account for each purchaser identified in the one or more assemblages of information, the purchaser account comprising a display of each of the at least one of the plurality of the products bought by the purchaser, where the display includes the vendor of each of the at least one of the plurality of the products bought by the purchaser and the warranty plan for each of the at least one of the plurality of the products bought by the purchaser;
storing the purchaser account in a database in the host system;
providing the purchaser with access to the purchaser account via a computer network;
transmitting a set of instructions to the purchaser over a computer network, the set of instructions including an instruction for accessing the host system via a computer network.

10. The process as set forth in claim 9, wherein the controlling warranty-related data and services further includes:
receiving a transmission over a computer network containing a request for repair, the request identifying at least one of the at least one product displayed in the purchaser account;
designating a repair center to repair each one of the at least one product identified in the request;
notifying a parcel delivery service to pick up each one of the at least one product identified in the request and deliver each one of the at least one product to a repair center designated by the host system;
notifying the repair center designated for each one of the at least one product for which the request for repair was made that each one of the at least one product identified in the request will be delivered for repair;
generating a repair report for each one of the at least one product identified in the request;
storing each one of the at least one repair report as a document maintained within the host system;
receiving one or more status updates from the parcel delivery service or the repair center containing information regarding the repair of each one of the at least one product identified in the request;
amending each one of the at least one repair report to reflect the information contained in one or more repair status updates; and
providing the purchaser with access to each one of the at least one repair report over a computer network.

11. The process as set forth in claim 10 wherein the receiving the one or more data transmissions into the host system further includes receiving the one or more data transmissions from each vendor identified in the one or more data transmissions.

12. The process as set forth in claim 11 wherein the controlling warranty-related data and services further includes:
providing the parcel delivery service and the repair center with access to the host system via a computer network;
receiving the one or more status updates via a transmission over a computer network; and
providing the parcel delivery service and the repair center with access to each one of the at least one repair report via a computer network.

13. The process as set forth in claim 12 wherein the controlling warranty-related data and services further includes:
processing the request to identify the vendor and the warranty plan corresponding to each one of the at least one product identified in the request;
notifying the vendor of each one of the at least one product identified in the request that the repair request was made; and
providing the vendor of each of the least one of the products identified in the request with access to the repair report corresponding to each of the at least one product identified in the request for which the vendor is identified.

14. The process as set forth in claim 13 wherein the controlling warranty related data and services further includes:
generating a parcel delivery service account document and a repair center account document for the parcel delivery service and the repair center notified of the request;
providing the parcel delivery service with access to the parcel delivery service account document over a computer network; and
providing the repair center with access to the repair center account document over a computer network.

15. The process as set forth in claim 14 wherein providing the purchaser, the vendor, the parcel delivery service, and the repair center for each of the at least one of the plurality of products sold with access to the host system includes providing a website including a user interface accessible over the Internet, the user interface providing one or more selectable options that, when at least one of the one or more options is selected, the repair report will be displayed.

16. A system for controlling warranty-related data and services, the system comprising:
a user interface accessible over a computer network for a plurality of users;
a data input/output component for receiving data containing warranty-related information over a computer network, transferring the data within the system, and transmitting the data over a computer network;
a database for storing the data within the system;
logic for processing the data containing warranty-related information to identify a product, and also identify a vendor, a purchaser, and a warranty plan corresponding to the product;
logic for establishing an association between the product, the vendor, the purchaser, and the warranty plan;
logic for generating a vendor account document and a purchaser account document;
logic for transmitting an electronic message to the purchaser upon receipt of the data containing warranty-related information;
logic for processing a request for a repair to the product and notifying a parcel delivery service and a repair center of the request;
logic for generating a repair report corresponding to the request for a repair;
logic for processing one or more status updates containing data regarding the status of the repair;
logic for amending the report to reflect the data regarding the repair;
logic for generating a parcel delivery service account document and a repair center account document; and
logic for displaying the vendor account document to the vendor, the purchaser account document to the purchaser, the parcel delivery service account document to the parcel delivery service, and the repair center account to the repair center, all over a computer network.
